(19) United States
(12) Patent Application Publication
(10) Pub. No.: US 2021/0388932 A1
(43) Pub. Date: Dec. 16, 2021

(54) SUMP BASIN INLET PIPE COUPLER ASSEMBLY AND METHOD

(71) Applicant: David Thomas Patterson, Carlos, MN (US)

(72) Inventor: David Thomas Patterson, Carlos, MN (US)

(21) Appl. No.: 16/898,111

(22) Filed: Jun. 10, 2020

(51) Int. Cl. F16L 41/14

(52) U.S. Cl. CPC F16L 41/14

(57) ABSTRACT

A sump basin inlet pipe coupler assembly includes comprising a panel that has an inner surface, an outer surface and a perimeter edge. The inner surface is concavely arcuate in a single direction extending from a first lateral edge to a second lateral edge to match a contoured surface of the sump basin. The panel has main aperture extending therethrough. A conduit has a cylindrical shape and has a first end, a second end. The conduit extends through the main aperture and a perimeter edge of the main aperture is coextensively integrally coupled to a perimeter wall of the conduit to define a sealing flange extending around the conduit. The panel and the conduit are comprised of a plastic. The first end of the conduit is extended through an outer wall of a sump basin to form an inlet connection point into the sump basin.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fluid basin coupler and more particularly pertains to a new fluid basin coupler for coupling an intake pipe to a sump basin. Particularly, the disclosure includes a plastic connection for connecting an inlet pipe to a sump basin that ensures a watertight seal that does not easily fail.

### (2) Description of Related Art Including Information Disclosed Under 37 CFR 1.97 and 1.98

The prior art relates to fluid basin couplers used for connecting inlets to sump basins. However, prior art couplers are comprised of metallic material, typically iron or steel, that are attached to the sump basin with one or more gaskets/washers are used to form a seal between a coupler flange and the wall of the sump basin. Such a structure has two primary deficiencies. The first is that the seal formed around the opening in the sump basin is difficult to establish and subsequently maintain as the gaskets degrade over time leading to leaks and corrosion. The second surrounds the connection between the inlet pipe and the coupler. Because the inlet pipe is typically comprised of a plastic material, such as PVC, the connection between the plastic pipe and metallic coupler cannot be continually established without eventual corrosion and degradation at their connection point. Therefore, the need exists for a connection that is free of maintenance and provides a long term seal.

### BRIEF SUMMARY OF THE INVENTION

An embodiment of the disclosure meets the needs presented above by generally comprising a panel that has an inner surface, an outer surface and a perimeter edge. The perimeter edge includes a top edge, a bottom edge, a first lateral edge and a second lateral edge. The inner surface is concavely arcuate in a single direction extending from the first lateral edge to the second lateral edge such that the inner surface matches a cylindrical contoured surface of the sump basin. The panel has main aperture extending therein extending through the inner and outer surfaces. A conduit has a cylindrical shape and has a first end, a second end and a perimeter wall that is attached to and extends between the first and second ends. Each of the first and second ends is open and the conduit extends through the main aperture such that the first end extends away from the inner surface and the second end extends away from the outer surface. A perimeter edge of the main aperture is coextensively integrally coupled to the perimeter wall. The panel defines a sealing flange extending around the conduit. The panel and the conduit is comprised of a plastic material such as PVC, CPVC or ABS plastic material. The first end of the conduit is extended through an outer wall of the sump basin and the panel is secured to the outer wall to form an inlet connection point into the sump basin.

In another embodiment, a method of using the structure described above includes extending the conduit through a primary aperture in an outer wall of the sump basin. The inner side of the panel is abutted against and secured to the outer wall with an adhesive. An inlet pipe is then coupled to the second end of the conduit to fluidly couple the inlet pipe to the sump basin. The inlet pipe is also comprised of a plastic material and a solvent is used to bind the inlet pipe to the conduit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of a sump basin inlet pipe coupler assembly and method according to an embodiment of the disclosure.

FIG. 2 is a top view of an embodiment of the disclosure.

FIG. 3 is an isometric front view of an embodiment of the disclosure.

FIG. 4 is an isometric rear view of an embodiment of the disclosure.

FIG. 5 is a side in-use view of an embodiment of the disclosure including a breakaway cross-section of a connection point of the assembly.

FIG. 6 is a cross-sectional view of an embodiment of the disclosure taken along line 6-6 of FIG. 4.

### DETAILED DESCRIPTION OF THE INVENTION

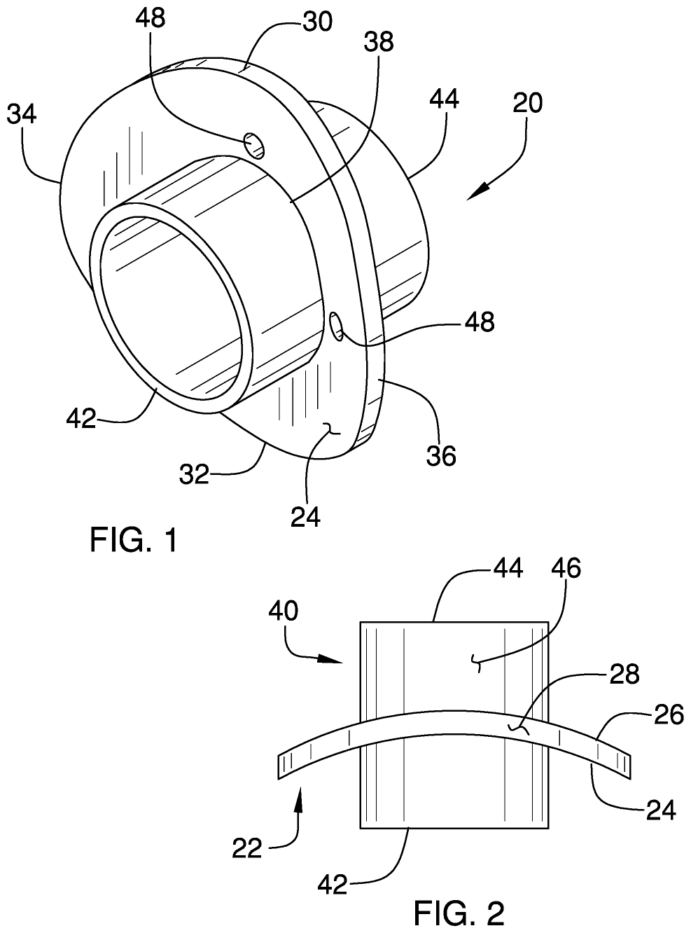

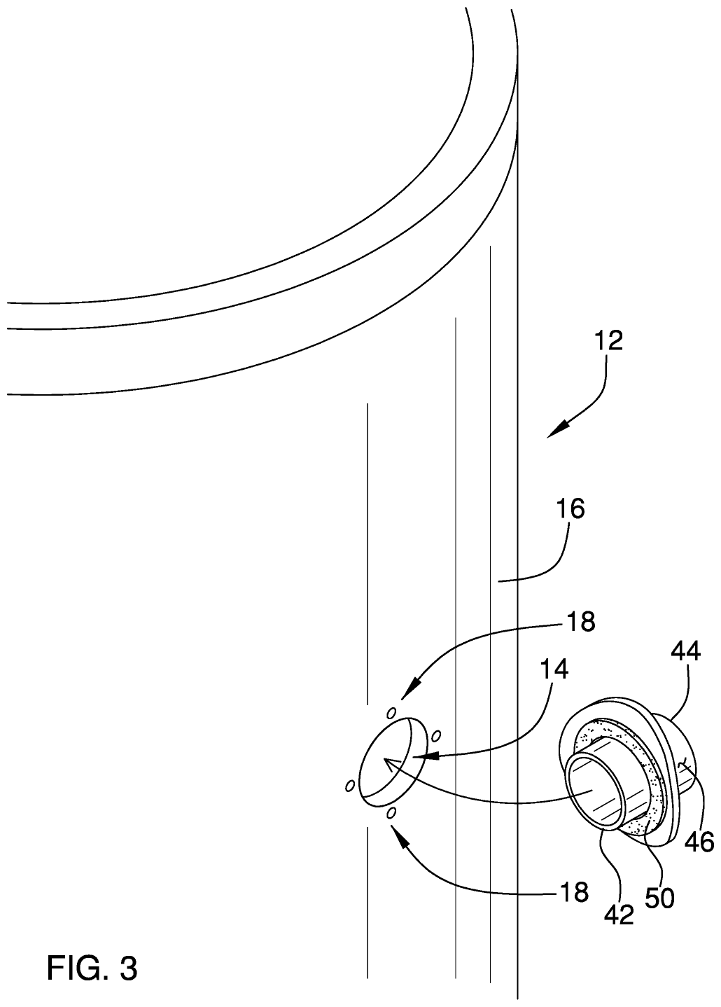

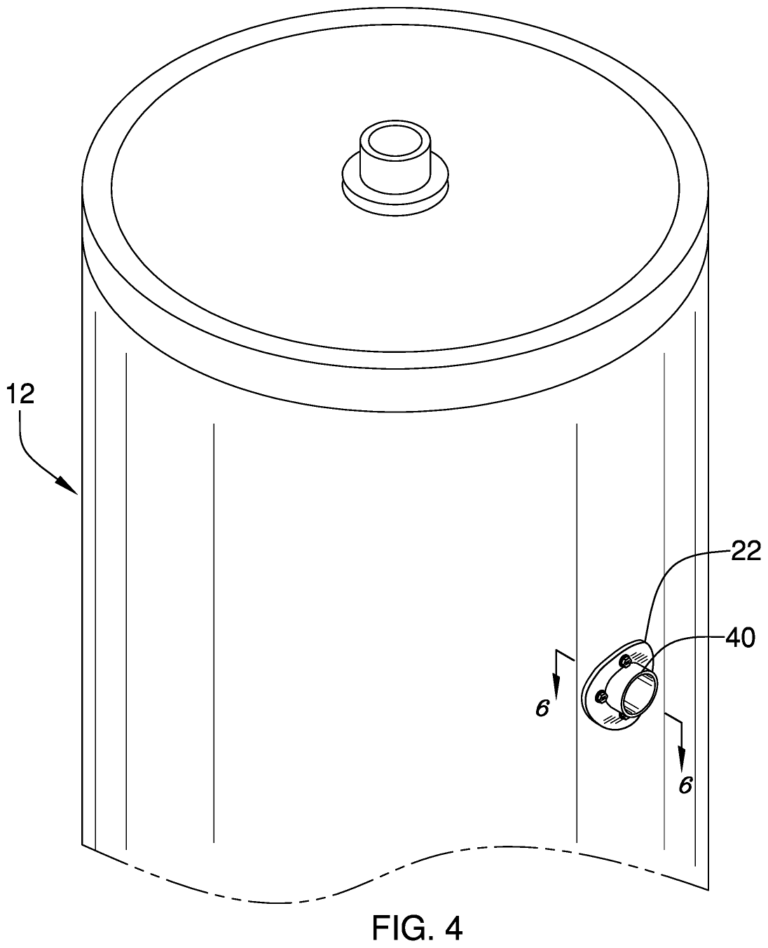

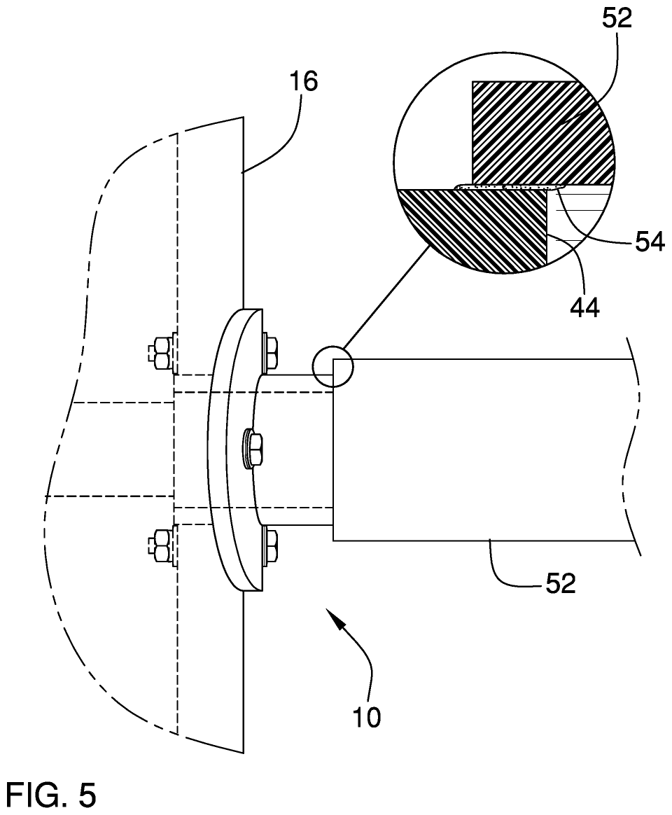

With reference now to the drawings, and in particular to FIGS. 1 through 6 thereof, a new fluid basin coupler embodying the principles and concepts of an embodiment of the disclosure and generally designated by the reference numeral 10 will be described.

As best illustrated in FIGS. 1 through 6, the sump basin inlet pipe coupler assembly 10 and method generally includes an assembly utilized with large sump basins 12 that, for example, are used to catch waste water and are often found on industrial sites and used by municipalities. Such sump basins 12 function as tanks can be quite large and are capable of holding several hundred gallons of fluid. The sump basins 12 include an inlet that carries drained fluid to the sump basin 12 such that it can be pumped away from the retention location. An example of such a system is made by Topp Industries located at 420 St. Road 25 N, Rochester, Ind.

In the method of using the assembly 10, the sump basin 12 has a primary opening 14 formed therein by cutting such through what is, typically, a fiberglass outer wall 16. The primary opening 14 may be any required size but in one example may be equal to 5.0 inches. A plurality of secondary openings 18 are then extended through the outer wall 16 and positioned adjacent to the primary opening 14. This may include four secondary openings 18 evenly spaced from each other and which will serve to receive fasteners 70 as discussed below.

A fitting 20 is provided which that is extended through the primary opening 14. The fitting 20 includes a panel 22 having an inner surface 24, an outer surface 26 and a perimeter edge 28. The perimeter edge 28 includes a top edge 30, a bottom edge 32, a first lateral edge 34 and a second lateral edge 36 and may have a generally continuous arcuate shape as can be seen in the figures. The inner surface 24 is concavely arcuate in a single direction extending from the first lateral edge 34 to the second lateral edge 36 such that the inner surface 24 matches a cylindrical contoured surface of the outer wall 16 of the sump basin 12. By stating that inner surface 24 is concavely arcuate in one direction, it is understood that the panel 22 is essentially linear from a center of the top edge 30 to a center of the bottom edge 32. The panel 22 has main aperture 38 extending therein extending through the inner 24 and outer 26 surfaces. The main aperture 38 is typically at least 2.5 inches and will often be a same size as the primary opening 14.

A conduit 40 has a cylindrical shape and has a first end 42, a second end 44 and a perimeter wall 46 is attached to and extends between the first 42 and second 44 ends. Each of the first 42 and second 44 ends is open. The conduit 40 extends through the main aperture 38 such that the first end 42 extends away from the inner surface 24 and the second end 44 extends away from the outer surface 26. As shown in the Figures, a perimeter edge of the main aperture 38 is coextensively integrally coupled to the perimeter wall 46. In some embodiments the conduit 40 and the panel 22 comprise a unitary structure, wherein the conduit 40 and panel 22 are formed together in a single mold or in two halves joined together. The conduit 40 has an outer perimeter diameter that is approximately equal to a diameter of the primary opening 16 such that it can slide into the primary opening 16 in a semi-tight fashion.

The panel 22 defines a sealing flange extending around the conduit 40 and extends away from the conduit 22 a distance of greater than 1.0 inches. The panel 22 has a plurality of fastener apertures 48 extending therein extending through the inner 24 and outer 26 surfaces. The size of the fastener apertures 48 are dependent upon the size of the fasteners 70 to be used and will usually have a diameter less than 0.75 inches and may match a size of the secondary openings 18. Each of the secondary openings 18 is alignable with one of the fastener openings 48.

An essential feature of the invention is that the panel 22 and the conduit 40 are comprised of a plastic material. Most typically the plastic material is a PVC (polyvinyl chloride) though other plastics conventionally used in the plumbing business may also be utilized. Thus CPVC (chlorinated polyvinyl plastic) or ABS (acrylonitrile butadiene styrene) plastics may also be used.

The first end 42 of the conduit 40 is extended through the primary opening 14 such that the inner surface 24 faces the outer wall 16 and a contour of the inner surface 24 is aligned with a contour of the outer wall 16. Also, the fastener apertures 48 are to be aligned with the secondary openings 18. A sealing adhesive 50 is positioned between the inner surface 24 and the outer wall 16 before or after extending the first end 42 through the primary opening 14. Most typically, the sealing adhesive 50 is first placed on the inner surface 24 before the conduit 40 is extended into the primary opening 14. While any sealing adhesive may be utilized, one particularly well suited for sealing the area around the primary 14 and secondary 18 openings is butyl tape, which is common and easily found from many suppliers. The sealing adhesive 50 is placed on the inner surface 24 adjacent to the conduit 40 and around or over the fastener apertures 48.

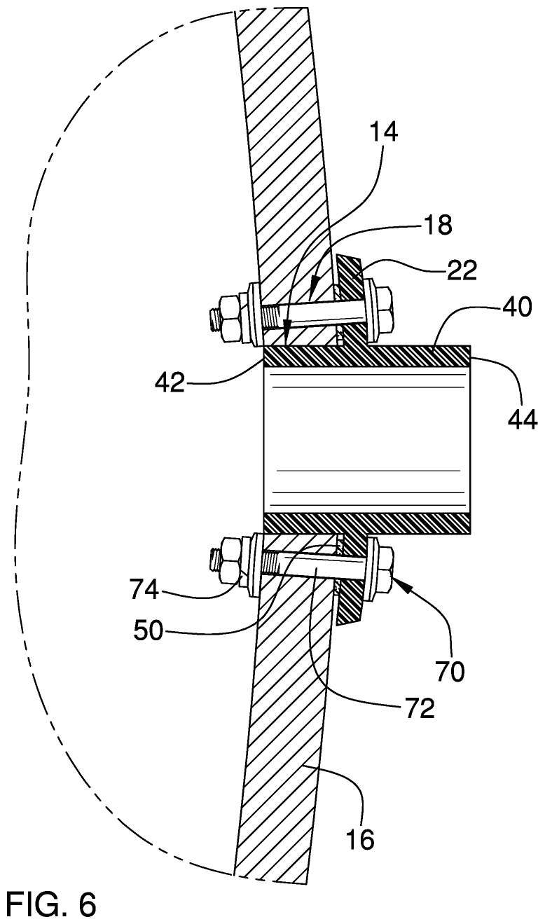

Fasteners 70 are then extended through aligned ones of the fastener apertures 48 and the secondary openings 18 to bias the panel 22 against the outer wall 16 such that the sealing adhesive 50 adheres the panel 22 to the outer wall 16 and forms a seal around the primary opening 14 and the secondary openings 18. As can be seen in the Figures, the fasteners 70 may include a threaded bolt 72 extended through the panel 22 and the outer wall 16 and secured in place with a nut 74 such that panel 22 is driven toward the outer wall 16 to prevent seepage through the primary 14 and secondary 18 openings. As can be seen in FIG. 6, washers may be utilized with the threaded bolt 72 and nut 74. The washers may include rubberized sides facing the outer wall 16 to facilitate a watertight seal.

An inlet pipe 52 is then coupled to the second end 42 of the conduit 40. The inlet pipe 52 is comprised of the plastic used with the conduit 40 to allow for chemical bonding between the inlet pipe 52 and the conduit 40. This is accomplished by using known methods of placing a solvent cement 54 on abutting surfaces of the inlet pipe 52 and conduit 40. When joined, the inlet pipe 52 and the conduit 40 are bonded together in a manner that prevents their separation while providing a watertight seal. Depending on the type of plastic utilized, a primer may be required to be used with solvent cement. This type of bonding resists failure as no corrosion can occur at the mating areas of the inlet pipe 52 and conduit 40.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A sump basin coupler assembly for fluidly engaging a sump basin with an inlet pipe, the assembly comprising:
a panel having an inner surface, an outer surface and a perimeter edge, the perimeter edge including a top edge, a bottom edge, a first lateral edge and a second lateral edge, the inner surface being concavely arcuate in a single direction extending from the first lateral edge to the second lateral edge such that the inner surface matches a cylindrical contoured surface of the sump basin;
the panel having main aperture extending therein extending through the inner and outer surfaces;
a conduit having a cylindrical shape and having a first end, a second end and a perimeter wall being attached to and extending between the first and second ends, each of the first and second ends being open, the conduit extending through the main aperture such that the first end extends away from the inner surface and the second end extends away from the outer surface;
a perimeter edge of the main aperture being coextensively integrally coupled to the perimeter wall, the panel defining a sealing flange extending around the conduit;
the panel and the conduit being comprised of a plastic material, the plastic material being comprised of a PVC, CPVC or ABS plastic material; and
wherein the first end of the conduit is extended through an outer wall of the sump basin and the panel secured to the outer wall to form an inlet connection point into the sump basin.

2. The assembly according to claim 1, wherein the main aperture has a diameter greater than 2.5 inches.

3. The assembly according to claim 1, wherein panel extends away from the conduit a distance greater than 1.0 inches.

4. The assembly according to claim 1, wherein the panel has a plurality of fastener apertures extending therein extending through the inner and outer surfaces.

5. The assembly according to claim 4, wherein each of the fastener apertures has a diameter being less than 0.75 inches.

6. A sump basin coupler assembly for fluidly engaging a sump basin with an inlet pipe, the assembly comprising:
a panel having an inner surface, an outer surface and a perimeter edge, the perimeter edge including a top edge, a bottom edge, a first lateral edge and a second lateral edge, the inner surface being concavely arcuate in a single direction extending from the first lateral edge to the second lateral edge such that the inner surface matches a cylindrical contoured surface of the sump basin;
the panel having main aperture extending therein extending through the inner and outer surfaces, the main aperture having a diameter greater than 2.5 inches;
a conduit having a cylindrical shape and having a first end, a second end and a perimeter wall being attached to and extending between the first and second ends, each of the first and second ends being open, the conduit extending through the main aperture such that the first end extends away from the inner surface and the second end extends away from the outer surface;
a perimeter edge of the main aperture being coextensively integrally coupled to the perimeter wall wherein the conduit and the panel comprise a unitary structure;
the panel defining a sealing flange extending around the conduit and extending away from the conduit a distance greater than 1.0 inches;
the panel having a plurality of fastener apertures extending therein extending through the inner and outer surfaces, each of the fastener apertures having a diameter being less than 0.75 inches;
the panel and the conduit being comprised of a plastic material, the plastic material being comprised of a PVC, CPVC or ABS plastic material; and
wherein the first end of the conduit is extended through an outer wall of the sump basin and the panel secured to the outer wall to form an inlet connection point into the sump basin.

7. A method of connecting an inlet pipe to a sump basin, the method comprising the steps of:
forming a primary opening extending through an outer wall of a sump basin;
forming a plurality of secondary openings extending through the outer wall and positioned adjacent to the primary opening;
providing a fitting for extending through the primary opening, the fitting including:
a panel having an inner surface, an outer surface and a perimeter edge, the perimeter edge including a top edge, a bottom edge, a first lateral edge and a second lateral edge, the inner surface being concavely arcuate in a single direction extending from the first lateral edge to the second lateral edge such that the inner surface matches a cylindrical contoured surface of the outer wall of the sump basin, the panel having main aperture extending therein extending through the inner and outer surfaces;
a conduit having a cylindrical shape and having a first end, a second end and a perimeter wall being attached to and extending between the first and second ends, each of the first and second ends being open, the conduit extending through the main aperture such that the first end extends away from the inner surface and the second end extends away from the outer surface, a perimeter edge of the main aperture being coextensively integrally coupled to the perimeter wall wherein the conduit and the panel comprise a unitary structure, the panel defining a sealing flange extending around the conduit and extending away from the conduit, the panel having a plurality of fastener apertures extending therein extending through the inner and outer surfaces, each of the secondary openings being alignable with one of the fastener openings, the panel and the conduit being comprised of a plastic material, the plastic material being comprised of a PVC, CPVC or ABS plastic material;
extending the first end of the conduit through the primary opening such that the inner surface faces the outer wall and a contour of the inner surface is aligned with a contour of the outer wall and the fastener apertures are aligned with the secondary openings;
positioning a sealing adhesive between the inner surface and the outer wall before or after extending the first end through the primary opening;
extending fasteners through aligned ones of the fastener apertures and the secondary openings to bias the panel against the outer wall such that the sealing adhesive adheres the panel to the outer wall and forms a seal around the primary opening; and
fluidly coupling an inlet pipe to the second end of the conduit, the inlet pipe being comprised of the plastic, wherein the step of fluidly coupling the inlet pipe to the conduit includes the step of positioning a solvent cement on abutting surfaces of the inlet pipe and conduit.
